(19) United States
(12) Patent Application Publication
(10) Pub. No.: US 2019/0240628 A1
(43) Pub. Date: Aug. 8, 2019

(54) APPARATUS AND METHOD FOR PRODUCING HYDROGEN WATER HAVING ANTIOXIDANT AND FINE DUST ACCUMULATION INHIBITING FUNCTIONS, AND HYDROGEN WATER PRODUCED USING THE SAME

(71) Applicant: Sung Pyo LEE, Seoul (KR)

(72) Inventors: Sung Pyo LEE, Seoul (KR); Kyung Sook OH, Seoul (KR)

(21) Appl. No.: 16/310,429

(22) PCT Filed: Jun. 19, 2017
(86) PCT No.: PCT/KR2017/006397

§ 371 Date: Dec. 15, 2018

(30) Foreign Application Priority Data
Jun. 17, 2016 (KR) 10-2016-0075454

(51) Int. Cl. B01F 3/04; B01D 35/02; B01F 15/02; C02F 1/32; C02F 1/44; C02F 1/68

(52) U.S. Cl. CPC B01F 3/04; B01D 35/02; C02F 1/68; C02F 1/32; C02F 1/44; B01F 15/02

(57) ABSTRACT

An apparatus and method produce hydrogen water that has antioxidant functions and abundantly contains dissolved hydrogen. Water is purified and sterilized for producing hydrogen water by supplying hydrogen gas to the purified and sterilized water. The hydrogen water is packaged into a container. The hydrogen gas is injected into the container to a saturated state by blowing. Leakage of the hydrogen gas is blocked by sealing the container. Since the concentration of hydrogen is increased to a saturated state by hydrogen blowing, a high-concentration hydrogen water is provided, and the shelf life is extended to two years, thereby enabling distribution of the hydrogen water without problem at stores. The hydrogen water has an excellent antioxidant function and suppresses the accumulation of fine dusts in a body, unlike general water, prevents, improves and treats pneumoconiosis caused by accumulation of fine dusts in lungs, and allergies and inflammations caused by fine dusts.

### TECHNICAL FIELD

The claim for priority under 35 U.S.C. § 119 is made to Korean Patent Application No. 10-2016-0075454 filed on Jun. 17, 2016 with the Korean Intellectual Property Office, the entire contents of which are herein incorporated by reference.

The present invention relates to the production of hydrogen water and more specifically, to an apparatus and a method for producing hydrogen water, having a unique configuration which allows hydrogen water to be enriched with dissolved hydrogen playing an effective role in preventing oxidation in the human body by blowing hydrogen, and to the use of hydrogen water, produced using the same, for suppressing the accumulation of particulate matter.

### DESCRIPTION OF THE RELATED ART

In general, oxygen inhaled into the body through breath is used in the process of oxidation, and part of the oxygen is turned into oxygen free radicals that are generated in the metabolic process, have strong oxidizing power, attacks biological tissue and damages cells. That is, oxygen free radicals mean oxygen, which are generated in the metabolic process, have strong oxidizing power, attacks biological tissue and damages cells while oxygen inhaled into the body through breath is being used in the process of oxidation, and are also referred to as toxic reactive oxygen species. Oxygen free radicals mean oxygen excessively produced due to environmental pollution, chemicals, ultraviolet rays, blood flow disorders, stress etc., and such excessively produced oxygen causes oxidation in the human body. Then cell membranes, DNA, and other cell structures are damaged and according to the scope of the damage, lose their functions and are adversely altered. As a result, various amino acids in the body oxidize, and proteins lose their functions. Additionally, nucleic acids are damaged. This causes the alteration and separation of nucleic acid bases, the excision of the paring of nucleic acid bases, and the oxidation and decomposition of sugar, etc., thereby causing mutation and cancer. Additionally, physiological functions are adversely affected, thereby causing various diseases such as diabetes, a stroke, myocardial infarction, hepatitis, nephritis, atopic dermatitis, Parkinson's disease and aging.

Such oxygen free radicals include singlet oxygen into which triplet oxygen (ordinary oxygen molecule) is turned by ultra violet rays, superoxide radicals generated by triplet oxygen receiving one electron, H₂O₂ generated by triplet oxygen receiving two electrons, hydroxyl radicals generated by means of the decomposition of H₂O₂, nitrogen monoxide, nitrogen dioxide, peroxidase, hypochlorous acid contained in tap water, ozone etc. However, oxygen free radicals herein do not mean an oxygen atom (O) in which an oxygen ion (O²⁻) loses electrons.

Meanwhile, it is known that hydrogen water is effective in discharge oxygen free radicals, a direct cause of aging and most doseases, out of the body. Lourdes spring water in France, Nordenau water in Germany, Tlacote water in Mexico, and Nadana water in India etc. are known for their effectiveness in treatment. They contain a large amount of active hydrogen.

Antioxidants such as Vitamin E, Vitamin C, uric acid, bilirubin, glutathione, carotene etc. are eaten so as to remove oxygen free radicals. However, such antioxidants have a more positive effect when they are naturally eaten. Thus, an apparatus for producing hydrogen water may be provided so as to enable water containing hydrogen to be drunk.

In general, hydrogen water is produced using magnetization, ultrasonic waves, ores, minerals or electrolysis etc. Among them, electrolysis is the most popular way of producing hydrogen water. Hydrogen water produced using electrolysis is referred to as electrolytic hydrogen water.

Hydrogen water is also called alkali ion water or hydrogen-rich water etc. and is used for drink, beauty, industry, agriculture etc.

As the effects of hydrogen water are widely known, apparatuses for producing hydrogen water have been developed in recent years. The below-described patent document 1 discloses a hydrogen water dispenser and a hydrogen water purifying device. The invention disclosed in patent document 1 is an example of an apparatus for producing hydrogen water. According to the invention, hydrogen water is produced by means of electrolysis, as described above. (Patent Document 1) Korean Laid-Open Patent Publication No. 10-2011-0052404 (published on May 18, 2011)

However, such conventional apparatuses for producing/generating hydrogen water simply electrolyze water so as to provide hydrogen water. Thus, produced hydrogen water has a low concentration of hydrogen. That is, the concentration of hydrogen of hydrogen water generated by means of electrolysis ranges from about 0.2 to about 0.6 ppm. It is hard to produce hydrogen water with a hydrogen concentration of 0.2 to 0.6 ppm or more through electrolysis. Further, it is difficult to maintain the hydrogen content in hydrogen water. Hydrogen is even lighter than other gases. In particular, hydrogen in conventional hydrogen water products escapes rapidly after the hydrogen water products are opened. Thus, the initial hydrogen concentration of a hydrogen water product is hardly maintained. Additionally, a significant amount of hydrogen water has to be taken into the body for a long time so that hydrogen water has a beneficial effect on the body. Therefore, more effective and efficient ways of taking hydrogen water into the body are necessary.

Meanwhile, as particulate matter including air pollution and yellow dust is one of the biggest issues, research into adverse effects of particulate matter on the human health has been performed recently. Dust falls into two categories according to its particle size: total suspended particles (TSP) the size of which is 50 μm or less and particulate matter (PM) the size of which is extremely small. Particulate matter falls into two categories: particulate matter (PM10) with a diameter of less than 10 μm and particulate matter (PM2.5) with a diameter of less than 2.5 μm. The World Health Organization (WHO) has issued air quality guidelines for particulate matter (PM10, PM2.5) since 1987. In 2013, the International Agency for Research on Cancer (IARC) under the auspices of WHO listed particulate matter as Group 1 carcinogen that can cause cancer. According to a report (Nel et al. Science, 2006), in relation to the number and surface area of dust per 10 μg/m³, if two dust particles (particels/ml of air) with a diameter of 2 μm exist in a unit space, 153 dust particles with a diameter of 0.5 μm exist in the same unit space, while 2,390,000 dust particles with a diameter of 0.02 μm exist in the same unit space. (Nel Al, Xia T, Madler L, Li N. Toxic potential of materials at the nanolevel. Science. 2006; 311(5761):622-7.). That is, if two dust particles with a diameter of 2 μm or less exist per cc (ml), hundreds of and tens of thousands of dust particles with a diameter of less than 2 μm exist per cc(ml). Thus, people, in fact, are exposed to an excessive amount of particulate matter (fine particulate matter).

Additionally, particulate matter is divided into two categories: primary particulate matter directly released into the atmosphere and secondary particulate matter formed by chemical reactions with other pollutants in the air. Primary particulate matter is made up of organic carbon, elemental carbon, ash (including heavy metals) etc. Secondary particulate matter falls into two categories: “secondary organic particulate matter” generated by means of an oxidation reaction between organic compounds, and hydroxide (OH), ozone (O₃), nitrate (NO₃) etc. and “secondary inorganic particulate matter” generated by means of a chemical reaction between sulfur dioxide, nitrate and ammonium etc., and ammonia, sulfur, nitric acid compounds in the air. In South Korea, secondary particulate matter is usually generated when fossil fuels are burned, and particulate matter from China, a country heavily dependent on coal which provides 70% of the country's energy, accounts for most of the secondary particulate matter. Additionally, yellow dust refers to a phenomenon in which fine sand, loess or dust coming from the sands and yellow soil zones in China or Mongolia etc. at the center of the Asian continent flows in the air and then flies far away by upper winds, and means long-range transported atmospheric pollutants.

Because the size of particulate matter (fine particulate matter) is extremely small, it reaches the bronchi and the sacs of the lungs at the end of the respiratory system. When particulate matter etc. is deposited at the sacs, pneumoconiosis develops, and the tissue of the lungs is damaged. Such particulate matter moves into the body through the blood vessels and makes people prone to inflammation in the body. Additionally, it makes cells sick. Specifically, pneumoconiosis means a respiratory disease in which dust is deposited in the lungs, and due to this, the tissue reaction occurs in the lungs. Dust denotes solid inorganic particles, and the tissue reaction in the lungs includes all the symptoms such as the inflammation, fibrosis and/or damage (scar) of the cells.

At a time when diseases (in particular, respiratory disease) caused by particulate matter including air pollution, yellow dust etc. poses a threat to human health, a simple and convenient means to prevent and block the accumulation (deposition) of particulate matter in the body for a long time and to immediately alleviate a disease caused by particulate matter is needed rather than a temporary means such as medication administration.

### DETAILED DESCRIPTION OF THE INVENTION

### Technical Problems

As described above, a conventional apparatus for producing hydrogen water electrolyzes water so as to produce hydrogen water. Thus, the concentration of hydrogen is very low, and the content of hydrogen is not maintained during storage.

As a means to solve the above-described problems, the present invention is directed to providing an apparatus and a method for producing hydrogen water and providing hydrogen water which is saturated with hydrogen so that high-concentration hydrogen may be provided, which maintains the content of high-concentration hydrogen on the market, the expiry date of which can be sufficiently extended, which inhibits oxidation, and which suppresses the accumulation of particulate matter.

Therefore, the present invention is directed to providing an apparatus for producing hydrogen water including:

a purification and sterilization part for purifying and sterilizing water for producing hydrogen water;

a hydrogen water forming part for providing hydrogen gas to the water having been purified and sterilized in the purification and sterilization part so as to form hydrogen water;

a hydrogen water packaging part for packaging the hydrogen water having been formed in the hydrogen water forming part into a hydrogen water container;

a hydrogen blower for blowing and injecting hydrogen gas into the hydrogen water container having gone through the hydrogen water packaging part to a saturated state; and

a seaming part for sealing the hydrogen water container after the hydrogen blower blows hydrogen so as to prevent the hydrogen gas from leaking.

The present invention is also directed to providing a method for producing hydrogen water including:

a first step of purifying and sterilizing water for producing hydrogen water;

a second step of providing hydrogen gas to the water having been purified and sterilized so as to form hydrogen water;

a third step of packaging the hydrogen water having been formed in the second step into a hydrogen water container;

a fourth step of blowing and injecting hydrogen gas into the hydrogen water container having gone through the third step to a saturated state; and

a fifth step of sealing the hydrogen water container after the hydrogen blower blows hydrogen gas so as to prevent the hydrogen gas from leaking.

The present invention is also directed to providing hydrogen water produced according to an apparatus or a method of the present invention.

The present invention is also directed to providing food composition for suppressing the accumulation of particulate matter in the body or discharging particulate matter out of the body, which includes hydrogen water of the present invention as an active ingredient.

The present invention is also directed to providing food composition for suppressing the accumulation of particulate matter or discharging particulate matter out of the body, which consists of hydrogen water of the present invention.

The present invention is also directed to providing food composition for suppressing the accumulation of particulate matter or discharging particulate matter out of the body, which essentially consists of hydrogen water of the present invention.

The present invention is also directed to providing food composition for preventing or alleviating pneumoconiosis, which includes hydrogen water of the present invention as an active ingredient.

The present invention is also directed to providing food composition for preventing or alleviating pneumoconiosis, which consist of hydrogen water of the present invention.

The present invention is also directed to providing food composition for preventing or alleviating pneumoconiosis, which essentially consists of hydrogen water of the present invention.

The present invention is also directed to providing food composition for preventing or alleviating allergy or inflammation caused by particulate matter, which includes hydrogen water of the present invention as an active ingredient.

The present invention is also directed to providing food composition for preventing or alleviating allergy or inflammation caused by particulate matter, which consists of hydrogen water of the present invention.

The present invention is also directed to providing food composition for preventing or alleviating allergy or inflammation caused by particulate matter, which essentially consists of hydrogen water of the present invention.

The present invention is also directed to providing pharmaceutical composition for preventing or treating pneumoconiosis, which includes hydrogen water of the present invention as an active ingredient.

The present invention is also directed to providing pharmaceutical composition for preventing or treating pneumoconiosis, which consists of hydrogen water of the present invention.

The present invention is also directed to providing pharmaceutical composition for preventing or treating pneumoconiosis, which essentially consists of hydrogen water of the present invention.

The present invention is also directed to providing pharmaceutical composition for preventing or treating allergy or inflammation caused by particulate matter, which includes hydrogen water of the present invention as an active ingredient.

The present invention is also directed to providing pharmaceutical composition for preventing or treating allergy or inflammation caused by particulate matter, which consists of hydrogen water of the present invention.

The present invention is also directed to providing pharmaceutical composition for preventing or treating allergy or inflammation caused by particulate matter, which essentially consists of hydrogen water of the present invention.

The present invention is also directed to providing use of hydrogen water of the present invention for preparing a formulation for suppressing the accumulation particulate matter in the body or discharging particulate matter out of the body.

The present invention is also directed to providing use of hydrogen water of the present invention for preparing a formulation for preventing or treating pneumoconiosis.

The present invention is also directed to providing use of hydrogen water of the present invention for preparing a formulation for preventing or treating allergy or inflammation caused by particulate matter.

The present invention is also directed to providing a method for suppressing the accumulation of particulate matter in the body or discharging particulate matter out of the body, which is characterized in that an effective amount of composition containing hydrogen water of the present invention is administered to a subject in need of the composition.

The present invention is also directed to providing a method for suppressing the accumulation of particulate matter in the body or discharging particulate matter out of the body, which is characterized in that an effective amount of composition consisting of hydrogen water of the present invention is administered to a subject in need of the composition.

The present invention is also directed to providing a method for suppressing the accumulation of particulate matter in the body or discharging particulate matter out of the body, which is characterized in that an effective amount of composition essentially consisting of hydrogen water of the present invention is administered to a subject in need of the composition.

The present invention is also directed to providing a method for preventing or treating pneumoconiosis, which is characterized in that an effective amount of composition including hydrogen water of the present invention is administered to a subject in need of the composition.

The present invention is also directed to providing a method for preventing or treating pneumoconiosis, which is characterized in that an effective amount of composition consisting of hydrogen water of the present invention is administered to a subject in need of the composition.

The present invention is also directed to providing a method for preventing or treating pneumoconiosis, which is characterized in that an effective amount of composition essentially consisting of hydrogen water of the present invention is administered to a subject in need of the composition.

The present invention is also directed to providing a method for preventing or treating allergy or inflammation caused by particulate matter, which is characterized in that an effective amount of composition including hydrogen water of the present invention is administered to a subject in need of the composition.

The present invention is also directed to providing a method for preventing or treating allergy or inflammation caused by particulate matter, which is characterized in that an effective amount of composition consisting of hydrogen water of the present invention is administered to a subject in need of the composition.

The present invention is also directed to providing a method for preventing or treating allergy or inflammation caused by particulate matter, which is characterized in that an effective amount of composition essentially consisting of hydrogen water of the present invention is administered to a subject in need of the composition.

### Technical Solutions

As a means to achieve the above-described purposes, an apparatus for producing hydrogen water according to the present invention includes a purification and sterilization part for purifying and sterilizing water for producing hydrogen water, a hydrogen water forming part for providing hydrogen gas to the water for producing hydrogen water having been purified and sterilized in the purification and sterilization part so as to form hydrogen water, a hydrogen water packaging part for packaging the hydrogen water having been formed in the hydrogen water forming part into a hydrogen water container, a hydrogen blower for blowing and injecting hydrogen gas into the hydrogen water container having gone through the hydrogen water packaging part to a saturated state, and a seaming part for sealing the hydrogen water container after the hydrogen blower blows hydrogen so as to prevent the hydrogen gas from leaking.

The apparatus for producing hydrogen water according to the present invention further includes a timing sensor for sensing the timing of blowing hydrogen gas by the hydrogen blower, and a liquid nitrogen insertion part for inserting liquid nitrogen into the hydrogen water container in accordance with the timing of blowing hydrogen gas, sensed by the timing sensor, so as to prevent hydrogen dissolved in the hydrogen water container from being eluted and to remove dissolved oxygen at the head space of the hydrogen water container.

Additionally, a method for producing hydrogen water according to the present invention includes a first step of purifying and sterilizing water for producing hydrogen water, a second step of providing hydrogen gas to the water for producing hydrogen water having been purified and sterilized so as to form hydrogen water, a third step of packaging the hydrogen water having been formed in the second step into a hydrogen water container, a fourth step of blowing and injecting hydrogen gas into the hydrogen water container having gone through the third step to a saturated state, and a fifth step of sealing the hydrogen water container after the hydrogen blower blows hydrogen gas so as to prevent the hydrogen gas from leaking.

The method for producing hydrogen water of the present invention further includes inserting liquid nitrogen into the hydrogen water container in accordance with the timing of blowing hydrogen gas, so as to prevent hydrogen dissolved in the hydrogen water container from being eluted and to remove dissolved oxygen at the head space of the hydrogen water container.

Additionally, the present invention provides hydrogen water produced using the apparatus or steps (producing method). Hydrogen water of the present invention has the advantage of containing hydrogen (maintaining the concentration of hydrogen) even at temperature higher than room temperature. Specifically, the hydrogen content of hydrogen water of the present invention in the state where the hydrogen water contacts air at the temperatures from 25° C. to 45° C. (i.e. state where the hydrogen water is unpackaged) for one or two hours accounts for 80 to 100%, preferably, 85 to 100% of the hydrogen content of hydrogen water of the present invention at the time when the hydrogen water contacts air for the first time (i.e. state where the hydrogen water is unpackaged for the first time). In this case, when unpackaged for the first time, the hydrogen content of hydrogen water ranges from 1.0 to 1.2 ppm. That is, the hydrogen content of hydrogen water of the present invention ranges from 0.8 ppm to 1.2 ppm in the state where the hydrogen water of the present invention contacts air at the temperatures from 0° C. to 45° C. for one or two hours (state where the hydrogen water is unpackaged). According to this inventor, at least 0.8 ppm of hydrogen concentration is effective in providing a beneficial effect on the body such as treatment of pneumoconiosis, and it is important to insert a constant amount of hydrogen. Considering the time spent when hydrogen water is absorbed in the body through a digestive duct etc., maintaining the amount of dissolved hydrogen for a long time is important in allowing hydrogen to be stably absorbed in the body up to a desired level, thereby making it possible to benefit the activation in the body. Additionally, hydrogen water of the present invention can be stably stored for a long time.

Additionally, hydrogen water produced according to the steps (method) of the present invention has excellent antioxidant activity, and unlike ordinary water, is excellent in suppressing the accumulation of particulate matter in the body and facilitating the discharge of particulate matter out of the lungs, thereby preventing, alleviating and treating pneumoconiosis caused by accumulated particulate matter. Further, the hydrogen water significantly prevents, alleviates and treats allergies or inflammation caused by particulate matter. The hydrogen water having such efficacy is disclosed for the first time in the present invention, and the efficacy is clearly shown in the experimental embodiments in this specification.

In experimental embodiment 3, when carbon nanoparticles were inserted into the bronchi of a mouse, a large amount of the carbon nanoparticles was accumulated in the lungs of the mouse, thereby damaging the lungs, increasing the weight of the lungs. When the blood was analyzed, it turned out that the immune function was suppressed and that an eosinophilic allergic reaction was caused. On the contrary, hydrogen water provided in the present invention has the advantage of significantly reducing accumulated particulate matter and damage to the lungs, thereby preventing and treating pneumoconiosis. The effects of hydrogen water of the present invention on suppressing the accumulation of particulate matter in the body and facilitating the discharge of particulate matter were re-confirmed through an experiment in which carbon nanoparticles were intravenously administered into the blood, and hydrogen water of the present invention was orally administered. In the experiment, the activation of phagocytes of macrophages and the rate of the removal of particulate matter increased. Additionally, hydrogen water of the present invention meaningfully reduced the number of eosinophils, thereby making it possible to suppress an allergic reaction and an inflammatory response caused by particulate matter.

The effects of hydrogen water of the present invention, produced according to the above-described apparatus and/or method of the present invention, are different from those of conventional hydrogen water products in which hydrogen gas is simply injected and those of hydrogen water produced by means of electrolytic reduction. Hydrogen produced in the present invention has the advantage of suppressing the accumulation of particulate matter in the body and of preventing, alleviating and treating pneumoconiosis.

Thus, the present invention provides food composition for suppressing the accumulation of particulate matter in the body or discharging particulate matter out of the body, which includes hydrogen water of the present invention as an active ingredient.

Additionally, the present invention provides food composition for suppressing the accumulation of particulate matter or discharging particulate matter out of the body, which consists of hydrogen water of the present invention.

Additionally, the present invention provides food composition for suppressing the accumulation of particulate matter or discharging particulate matter out of the body, which essentially consists of hydrogen water of the present invention.

Additionally, the present invention provides food composition for preventing or alleviating pneumoconiosis, which includes hydrogen water of the present invention as an active ingredient.

Additionally, the present invention provides food composition for preventing or alleviating pneumoconiosis, which consist of hydrogen water of the present invention.

Additionally, the present invention provides food composition for preventing or alleviating pneumoconiosis, which essentially consists of hydrogen water of the present invention.

Additionally, the present invention provides food composition for preventing or alleviating allergy or inflammation caused by particulate matter, which includes hydrogen water of the present invention as an active ingredient.

Additionally, the present invention provides food composition for preventing or alleviating allergy or inflammation caused by particulate matter, which consists of hydrogen water of the present invention.

Additionally, the present invention provides food composition for preventing or alleviating allergy or inflammation caused by particulate matter, which essentially consists of hydrogen water of the present invention.

Additionally, the present invention provides pharmaceutical composition for preventing or treating pneumoconiosis, which includes hydrogen water of the present invention as an active ingredient.

Additionally, the present invention provides pharmaceutical composition for preventing or treating pneumoconiosis, which consists of hydrogen water of the present invention.

Additionally, the present invention provides pharmaceutical composition for preventing or treating pneumoconiosis, which essentially consists of hydrogen water of the present invention.

Additionally, the present invention provides pharmaceutical composition for preventing or treating allergy or inflammation caused by particulate matter, which includes hydrogen water of the present invention as an active ingredient.

Additionally, the present invention provides pharmaceutical composition for preventing or treating allergy or inflammation caused by particulate matter, which consists of hydrogen water of the present invention.

Additionally, the present invention provides pharmaceutical composition for preventing or treating allergy or inflammation caused by particulate matter, which essentially consists of hydrogen water of the present invention.

Additionally, the present invention provides use of hydrogen water of the present invention for preparing a formulation for suppressing the accumulation particulate matter in the body or discharging particulate matter out of the body.

Additionally, the present invention provides use of hydrogen water of the present invention for preparing a formulation for preventing or treating pneumoconiosis.

Additionally, the present invention provides use of hydrogen water of the present invention for preparing a formulation for preventing or treating allergy or inflammation caused by particulate matter.

Additionally, the present invention provides a method for suppressing the accumulation of particulate matter in the body or discharging particulate matter out of the body, which is characterized in that an effective amount of composition including hydrogen water of the present invention is administered to a subject in need of the composition.

Additionally, the present invention provides a method for suppressing the accumulation of particulate matter in the body or discharging particulate matter out of the body, which is characterized in that an effective amount of composition consisting of hydrogen water of the present invention is administered to a subject in need of the composition.

Additionally, the present invention provides a method for suppressing the accumulation of particulate matter in the body or discharging particulate matter out of the body, which is characterized in that an effective amount of composition essentially consisting of hydrogen water of the present invention is administered to a subject in need of the composition.

Additionally, the present invention provides a method for preventing or treating pneumoconiosis, which is characterized in that an effective amount of composition including hydrogen water of the present invention is administered to a subject in need of the composition.

Additionally, the present invention provides a method for preventing or treating pneumoconiosis, which is characterized in that an effective amount of composition consisting of hydrogen water of the present invention is administered to a subject in need of the composition.

Additionally, the present invention provides a method for preventing or treating pneumoconiosis, which is characterized in that an effective amount of composition essentially consisting of hydrogen water of the present invention is administered to a subject in need the composition.

Additionally, the present invention provides a method for preventing or treating allergy or inflammation caused by particulate matter, which is characterized in that an effective amount of composition including hydrogen water of the present invention is administered to a subject in need of the composition.

Additionally, the present invention provides a method for preventing or treating allergy or inflammation caused by particulate matter, which is characterized in that an effective amount of composition consisting of hydrogen water of the present invention is administered to a subject in need of the composition.

Additionally, the present invention provides a method for preventing or treating allergy or inflammation caused by particulate matter, which is characterized in that an effective amount of composition essentially consisting of hydrogen water of the present invention is administered to a subject in need of the composition.

That is, the hydrogen content of hydrogen water of the present invention, which has the above-described efficacy, ranges from 0.8 ppm to 1.2 ppm, and as described above, hydrogen water of the present invention may contain the above-described amount of hydrogen for a long time. Specifically, in the state where the hydrogen water of the present invention contacts air at the temperatures from 0° C. to 45° C. for one or two hours (state where the hydrogen water is unpackaged), the hydrogen water of the present invention may contain 0.8 ppm to 1.2 ppm of hydrogen.

The wording “particulate matter” in the present invention denotes dust the particle of which is extremely small and includes dust produced by burning fossil fuels, air pollution, yellow dust etc. and particles known as particulate matter including primarily produced dust and secondarily produced dust in the art to which the present invention pertains regardless of the types and sizes of particles. Preferably, particulate matter of the present invention may denote dust particles the diameter of which ranges from 10 nm to 10 μm, and more preferably, denote dust particles the diameter of which ranges from 20 nm to 500 nm. Additionally, particulate matter of the present invention may preferably be particulate matter containing carbon and the like.

The term “accumulation” in the present invention includes the meaning of deposition and indicates not only a phenomenon where substances are gathered and piled but also a phenomenon where substances are sunk and attached.

The term of pneumoconiosis in the present invention means a respiratory disease in which dust is deposited in the lungs, and the tissue reaction occurs. The term of dust in the present invention may be understood as including particulate matter. Pneumoconiosis is classified into silicosis, anthracosis, asbestosis pulmonum etc. on the basis of the types of dust. However, pneumoconiosis in the present invention includes respiratory diseases known as pneumoconiosis in the art to which the present invention pertains. Pneumoconiosis in the present invention may preferably mean anthracosis and a respiratory disease in which a tissue reaction occurs in the lungs due to dust containing carbon or particulate matter, and includes a disease such as coal worker's pneumoconiosis etc.

The wording “allergy or inflammation caused by particulate matter” includes diseases caused by particulate matter and known as allergy or inflammation in the art to which the present invention pertains, regardless of the types of allergy and the body parts affected by allergy. For instance, allergy or inflammation includes lung inflammation caused by particulate matter etc.

The “effective amount” in the present invention means an enough amount to suppress the accumulation of particulate matter in the body, facilitate the discharge of particulate matter from the body, and prevent, alleviate and treat pneumoconiosis, or allergy or inflammation caused by particulate matter when hydrogen water of the present invention is administered to a subject. The term “subject” preferably may mean mammals, in particular, animals including humans, and the cell, tissue, organ etc. of an animal. The subject may mean a patient requiring the above-described effects.

The term “formulation” or “composition” in the present invention may be configured as food composition or pharmaceutical composition etc., and food composition and pharmaceutical composition are the same as what will be described below.

Food compositions of the present invention include compositions of all types of food such as functional food, nutritional supplements, health food, food additives etc. Such food compositions may be produced in various forms according to common methods well-known in the art to which the present invention pertains. For instance, a food composition of the present invention as health food may be produced in the forms of tea, juice and a drink. A food composition of the present invention as functional food may include ingredients such as proteins, carbohydrates, lipids, nutrients and seasoning, which are commonly added when food is produced. For instance, when produced in the form of a drink, food compositions of the present invention may further include citric acid, liquid fructose, sugar, glucose, acetic acid, malic acid, fruit juice, jujube extract, liquorice extract etc., besides hydrogen water of the present invention.

Food compositions of the present invention may further include food additives acceptable in sitology. Such food additives include food additives such as flavorings, dyes, fillers, stabilizers etc., which are commonly used in the art to which the present invention pertains. The other food compositions of the present invention may contain fruit pulp for the production of natural fruit juice, a fruit juice drink and a vegetable drink. Such ingredients may be used independently or mixedly. The ratio of the food additives is not important. Generally, the ratio of the food additives is selected within a range of 0.1 to about 20 parts by weight of the food additives with respect to 100 parts by weight of composition of the present invention.

Pharmaceutical compositions of the present invention may further include antioxidants, preservatives, stabilizers, sweeteners, flavorings etc. acceptable in pharmacy. For reference, such additives acceptable in pharmacy are listed in the following document (Remington's Pharmaceutical Sciences, 19th ed., Mack Publishing Company, Easton, Pa., 1995).

Pharmaceutical compositions of the present invention may be administered to mammals including humans using any method. For instance, pharmaceutical compositions of the present invention may be orally and parenterally administered. Parenteral administration includes administration in the veins, muscles, arteries, bone marrows, dura mater, heart, skin, subcutaneous tissue, abdominal cavity, nasal cavity, intestinal tract, local part, rectum, or under the tongue but not limited to what has been described.

Pharmaceutical composition of the present invention may be prepared as a formulation for oral administration or parenteral administration according to the above described route of administration. Such dosage forms are listed in a document (Remington's Pharmaceutical Science, 15th Edition, 1975. Mack Publishing Company, Easton, Pa. 18042, Chapter 87: Blaug, Seymour), generally known as a formulary in the field of pharmaceutical chemistry.

A total effective amount of hydrogen water of the present invention may be administered to a patient in a single dose, or in multiple doses for a long time on the basis of a fractionated treatment protocol. The content of an active ingredient in pharmaceutical composition of the present invention may vary according to disease severity. Preferably, a total amount of hydrogen water of the present invention ranges from 10 mL to 30 mL, and most preferably, from 16 mL to 20 mL per kg of the body weight of a patient.

However, an effective dose of hydrogen water of the present invention, which will be administered to a patient, is determined considering various factors such as the age, body weight, health condition, gender, disease severity, diet of the patient, the rate at which body waste of the patient is discharged etc. in addition to the route of administration of hydrogen water of the present invention and frequency of treatment. In relation to this, a person having ordinary skill in the art to which the present invention pertains may determine an effective dose according to the specific use of hydrogen water of the present invention such as the prevention of pneumoconiosis or the treatment of pneumoconiosis. Dosage forms, routes of administration and methods of administration of pharmaceutical composition according to the present invention are not limited to particular ones as long as the pharmaceutical composition has the same effect as the present invention.

The wording “comprising” set forth herein has the same meaning of the wording “containing” or “being characterized by” and does not imply the exclusion of an additional ingredient, an additional element or an additional method, an additional step etc. that are not mentioned in terms of compositions or methods. The wording “consisting of” implies the exclusion of an additional element, an additional step or an additional ingredient etc. that are not separately described. The wording “consisting essentially of” implies the inclusion of an ingredient, an element or a step etc. that does not substantially affect a described ingredient, a described element, or a described step and basic features thereof in terms of the scope of compositions or methods.

### Advantageous Effects

The effects of the present invention configured as described above are described as follows.

First, the present invention may provide high-concentration hydrogen water saturated with hydrogen by blowing hydrogen.

Second, unlike conventional hydrogen water products in which the content of hydrogen is not maintained and the shelf life of which is from four months to six months, the present invention charges a hydrogen water container with hydrogen so that the shelf life of hydrogen water of the present invention may extend up to two years. Thus, hydrogen water of the present invention may be sold in the market.

Third, hydrogen water produced according to the present invention may be used for various industries such as the beverage industry, the medical industry, the cosmetics industry, the agricultural industry etc. in the future. Unlike ordinary water, hydrogen water of the present invention has the advantage of preventing oxidation in the human body, of preventing the accumulation of particulate matter in the body, of preventing, alleviating and treating pneumoconiosis caused by particulate matter accumulated (deposited) in the lungs, and of preventing, alleviating and treating allergy or inflammation caused by particulate matter.

### BRIEF DESCRIPTION OF THE DRAWINGS

The following drawings attached in this specification illustrate preferred embodiments of the present invention and are provided together with the detailed description of the present invention so that the technical spirit of the present invention may be better understood. Therefore, the present invention should not be limited to what is illustrated in the drawings.

FIG. 1 is a block diagram illustrating an embodiment of an apparatus for producing hydrogen water according to the present invention.

FIG. 2 is a process view illustrating an embodiment of a method for producing hydrogen water according to the present invention.

FIG. 3 illustrates results of measuring changes in the concentration of hydrogen present in a conventional hydrogen water product and a hydrogen water product produced according to the present invention at 10-minute intervals for an hour after the products are opened.

FIG. 4 illustrates results of measuring changes in the concentration of hydrogen present in a conventional hydrogen water product and a hydrogen water product produced according to the present invention at one-month intervals for 12 months in the state the products not opened, so as to estimate the long-term preservation of the products.

FIG. 5A illustrates an outline of an animal experiment performed so as to confirm the effects of hydrogen water of the present invention on an animal model with pneumoconiosis.

FIG. 5B specifically illustrates a method for directly spraying carbon nanoparticles (CNP) into the bronchi of a rat.

FIG. 6 illustrates changes in the body weight of each experimental group (four weeks, three weeks, two weeks, one week) prior to the onset of pneumoconiosis and (one week, two weeks, three weeks, four weeks, five weeks, six weeks) after the onset of pneumoconiosis.

FIG. 7A illustrates results of measuring levels on which particulate matter is accumulated in the lung tissue of animal models with pneumoconiosis on the basis of each experimental group.

FIG. 7B illustrates results of measuring levels on which the lung tissue of animal models with pneumoconiosis is damaged on the basis of each experimental group.

FIG. 8A illustrates results of measuring levels on which particulate matter is accumulated (or removed) in the blood of each experimental group through an absorbance measurement after particulate matter (carbon) is directly injected into the blood.

FIG. 8B illustrates levels on which the phagocytosis of macrophages of each experimental group is activated after particulate matter (carbon) is directly injected into the blood.

FIG. 9A illustrates effects of purified water on a group where an inflammation response (production of nitric oxide from macrophages) is induced with IFN-y and LPS.

FIG. 9B illustrates effects of hydrogen water of the present invention on a group where an inflammation response (production of nitric oxide from macrophages) is induced with IFN-γ and LPS.

### MODE FOR CARRYING OUT THE INVENTION

Preferred embodiments of the present invention will be specifically described below with reference to the attached drawings so that a person having ordinary skill in the art to which the present invention pertains may easily embody the present invention. However, in specifically describing a theory of the operation of preferred embodiments of the present invention, detailed description of the well-known functions and configurations in relation to the present invention will be omitted if it is deemed to make the gist of the present invention unnecessarily vague.

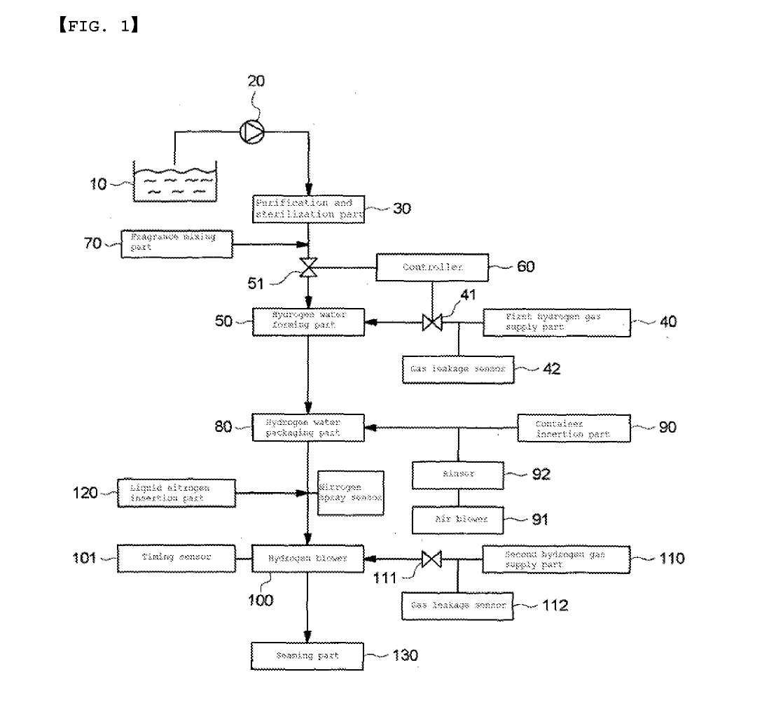

FIG. 1 is a block diagram illustrating an embodiment of an apparatus for producing hydrogen water according to the present invention, and components of the apparatus are specifically described as follows.

Water for producing hydrogen water is prepared in a water collecting container 10, the water for producing hydrogen water is transferred to a purification and sterilization part 30 through a pump 20. The purification and sterilization part filters the water for producing hydrogen water and sterilizes the same with ultraviolet rays (UV).

Various filtering means such as a carbon filter, a reverse osmosis (RO) membrane filter, a UV sterilization filter etc. may be applied to the purification and sterilization part 30. Such filters are consecutively connected so as to form a purification and sterilization part 30. Thus, heavy metals or harmful substances of the water for producing hydrogen water having been supplied to the purification and sterilization part 30 from the water collecting container 10 are removed in the purification and sterilization part 30.

Hydrogen gas supplied by a first hydrogen gas supply part is injected into the water for producing hydrogen water having been purified and sterilized in the purification and sterilization part 30 so that the water for producing hydrogen water is produced as hydrogen water containing hydrogen water in a hydrogen water forming part 50. That is, hydrogen gas with at least 99.99% purity exists at high pressure in the first hydrogen gas supply part 40. For instance, hydrogen gas may be continuously supplied to the hydrogen water forming part 50 through an automatic transfer switch 41 and a pressure regulator (invisible) at the pressure of 0.4 MPa.

A water supply valve 51 is provided between the hydrogen water forming part 50 and the purification and sterilization part 30 so that a sealed space is formed at the hydrogen water forming part. Thus, the hydrogen water forming part 50 is not provided with a separate container. Additionally, the hydrogen water forming part is supplied with water for producing hydrogen water through the purification and sterilization part 30 from the water collecting container 10 only when the water supply valve 51 is opened while being configured to be completely sealed from the outside when the water supply valve 51 is blocked. As a result, hydrogen gas in the hydrogen water forming part 50 is not discharged outward so that pressure in the hydrogen water forming part is raised, thereby making it possible to improve the dissolution rate of hydrogen gas. The opening and closing of the automatic transfer switch 41, the pressure regulator, and the water supply valve 51 is controlled by a controller 60.

A gas leakage sensor 42 for sensing the leakage of hydrogen gas may be installed at the first hydrogen gas supply part 40. When the leakage of hydrogen gas from a pipe, supplying hydrogen gas from the first hydrogen gas supply part 40 to the hydrogen water forming part 50, is sensed by the gas leakage sensor 42, an alarm goes off and at the same time, the operation of the first hydrogen gas supply part 40, the automatic transfer switch 41 and the pressure regulator is stopped according to the control of the controller 60.

Meanwhile, a pipe connecting from the purification and sterilization part 30 to the hydrogen water forming part 50 may be further provided with a fragrance mixing part 70. The fragrance mixing part 70 mixes fragrance into water for producing hydrogen water so as to improve the flavor of produced hydrogen water.

Next, hydrogen water having been produced in the hydrogen water forming part 50 is transferred to a hydrogen water packaging part 80 and packaged in a hydrogen water container such as a can (e.g. aluminum can (240Ml). That is, a container insertion part 90 is connected with the hydrogen water packaging part 80 by a means such as a conveyor belt etc. Thus, a hydrogen water container such as a can (hollow container) is transferred and inserted from the container insertion part 90 into the hydrogen water packaging part 80, and the hydrogen water packaging part 80 charges the hydrogen water container with hydrogen water.

An air blower 91, which sprays air in the hydrogen water container and cleans the same so as to remove foreign substances that may exist in the hydrogen water container, may be provided inside the hydrogen water container before the hydrogen water container is transferred from the container insertion part 90 to the hydrogen water packaging part 80. The hydrogen water container may be further provided with a rinser for cleaning the inside of the hydrogen water container with water having the pressure of 0.07 MPa after the air blower 91 sprays air.

As described above, the concentration of hydrogen packaged in a hydrogen water container by the hydrogen water packaging part 80 is not enough. Thus, the present invention is provided with a hydrogen blower 100 that blows and injects hydrogen gas to a saturated state inside the hydrogen water container having gone through the hydrogen water packaging part 80 by blowing. That is, the hydrogen blower 100 is connected with a second hydrogen gas supply part 110 through a pipe, and hydrogen gas with at least 99.99% purity exists in the second hydrogen gas supply part 110 at high pressure. For instance, hydrogen gas may be continuously supplied to the hydrogen blower 100 through an automatic transfer switch 111 and a pressure regulator (invisible) at the pressure of 0.2 MPa.

A gas leakage sensor 112 for sensing the leakage of hydrogen gas may be installed at the second hydrogen gas supply part 110. When the leakage of hydrogen gas from a pipe, supplying hydrogen gas from the second hydrogen gas supply part 110 to the hydrogen blower 100, is sensed by the gas leakage sensor 112, an alarm goes off and at the same time, the operation of the second hydrogen gas supply part 110, the automatic transfer switch 111 and the pressure regulator is stopped according to the control of the controller 60.

Meanwhile, a timing sensor 101 for sensing the timing of blowing hydrogen gas by the hydrogen blower 100 may be installed at the hydrogen blower 100. Additionally, the hydrogen blower 100 may be provided with a liquid nitrogen insertion part 120 for inserting liquid nitrogen into the hydrogen water container in accordance with the timing of blowing hydrogen gas, sensed by the timing sensor 101, so as to prevent hydrogen dissolved in the hydrogen water container from being eluted and remove dissolved oxygen. Further, a nitrogen spray sensor 121 for sensing whether nitrogen is sprayed or not may be installed at the liquid nitrogen insertion part 120.

When the timing sensor 101 senses that the hydrogen blower 100 blows hydrogen gas into the hydrogen water container, the liquid nitrogen insertion part 120 immediately sprays liquid nitrogen at the head space of the hydrogen water container. Thus, hydrogen dissolved in the hydrogen water container is prevented from being eluted, oxygen in the head space of the hydrogen water container is blocked from being dissolved, and the head space of the hydrogen water container is saturated with hydrogen gas so as to supply high-concentration hydrogen water.

For reference, when the hydrogen blower 100 blows high-pressure hydrogen gas, an air conditioner for preventing an explosion (invisible) or a ventilator for preventing an explosion (invisible) is preferably further installed at the hydrogen blower 100.

Next, a seaming part 130 is provided so as to perform seaming and completely seal the hydrogen water container in the state where the hydrogen water container is charged with high-concentration hydrogen. That is, the seaming part 130 seals the hydrogen water container after the hydrogen blower 100 blows hydrogen gas so as to prevent hydrogen gas from leaking. In this case, acrylic plates are preferably installed around the seaming part 130 so as to prevent hydrogen gas from leaking.

208. Next, though not illustrated in the drawings, a means to sterilize and cool the hydrogen water container, a data coating means to display an expiry date etc. on the hydrogen water container, a weight testing means to confirm whether the weight of the contents in the hydrogen water container is normal, an inner pressure testing means to confirm whether the pressure in the hydrogen water container is normal, etc. maybe further included in the present invention.

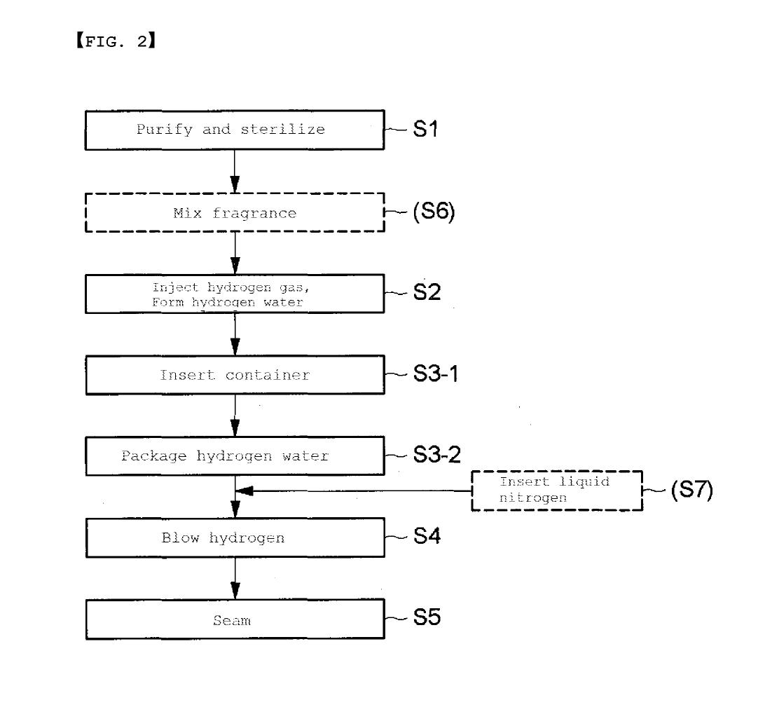

Below, embodiments of a method for producing hydrogen water having an antioxidant function according to the present invention will be described with reference to FIGS. 1 and 2.

As in the above-described embodiment of an apparatus for producing hydrogen water, water for producing hydrogen water prepared in a water collecting container 10 is transferred to a purification and sterilization part 30, and is purified and sterilized (S1). That is, in the purification and sterilization step (S1), water for producing hydrogen water is filtered so that foreign substances are removed, and is sterilized and disinfected with ultraviolet rays (UV). In this case, various filtering means such as a carbon filter, a reverse osmosis (RO) membrane filter, a UV sterilization filter etc. are preferably connected consecutively so as to remove heavy metals or harmful substances of the water for producing hydrogen water having been supplied from the water collecting container 10 until the water for producing hydrogen water reaches to a safe level.

Next, hydrogen water is formed using hydrogen supplied from a first hydrogen gas supply part 40 in a hydrogen water forming part 50 (S2). That is, hydrogen gas is continuously supplied to the hydrogen water forming part 50, for instance, at the pressure of 0.4 MPa from the first hydrogen gas supply part 40 in which hydrogen gas with at least 99.99% purity exists at high pressure so as to produce hydrogen water containing hydrogen water in the hydrogen water forming part 50. Hydrogen gas is injected in the first hydrogen gas supply part at the temperature of 18° C. to 25° C., and preferably, pressure supplied in the first hydrogen gas supply part may range from 0.2 MPa to 0.4 MPa. More specifically, hydrogen gas is preferably supplied in the first hydrogen gas supply part by means of a double pressing method in which hydrogen gas is sprayed continuously in the first hydrogen gas supply part at the pressure of 0.4 MPa and at the same time, the hydrogen gas is dissolved in water while the pressure of 0.2 MPa is applied in the first hydrogen gas supply part.

In particular, a water supply valve 51 is provided between the hydrogen water forming part 50 and the purification and sterilization part 30 so that a sealed space is formed at the hydrogen water forming part. Thus, the hydrogen water forming part 50 is not provided with a separate container. Additionally, the hydrogen water forming part is supplied with water for producing hydrogen water through the purification and sterilization part 30 from the water collecting container 10 only when the water supply valve 51 is opened while being configured to be completely sealed from the outside when the water supply valve 51 is blocked. Thus, hydrogen gas in the hydrogen water forming part 50 is not discharged outward so that pressure in the hydrogen water forming part is raised, thereby making it possible to improve the dissolution rate of hydrogen gas.

Next, a hydrogen water container is inserted into a hydrogen water packaging part 80 for packaging hydrogen water produced in the hydrogen water forming part 50 into a hydrogen water container such as a can (S3-1). That is, a container insertion part 90 is connected with the hydrogen water packaging part 80 by a means such as a conveyor belt etc. so that a hydrogen water container such as a can (hollow container, in particular, aluminum can) is transferred and inserted from the container insertion part 90 into the hydrogen water packaging part 80.

Meanwhile, an air blower 91 preferably sprays air into a hydrogen water container before the hydrogen water container is transferred to the hydrogen water packaging part 80 from the container insertion part 90 so as to remove foreign substances that may exist in the hydrogen water container, and a rinser 92 preferably cleans the inside of the hydrogen water container with water having the pressure of 0.07 MPa after the air blower 91 blows air.

Next, the hydrogen water container inserted into the hydrogen water packaging part 80 is charged with hydrogen water and packaged (S3-2).

Next, a hydrogen blower 100 blows and injects hydrogen gas to a saturated state inside the hydrogen water container having gone through the hydrogen water packaging part 80 by blowing (S4). That is, hydrogen gas is continuously supplied to the hydrogen blower 100 from a second hydrogen gas supply part 110 in which hydrogen gas with at least 99.99% purity exists at high pressure, for instance, at the pressure of 0.2 MPa, so that high-concentration hydrogen water charges the hydrogen water container.

Next, a seaming part 130 performs seaming so as to completely seal the hydrogen water container in the state where the hydrogen water container is charged with high-concentration hydrogen (S5). That is, the seaming part 130 completely seals the hydrogen water container after the hydrogen blower 100 blows hydrogen gas so as to prevent hydrogen gas from leaking.

Meanwhile, a step of mixing fragrance into water for producing hydrogen water may be further included (S6) while the water for producing hydrogen water is transferred from the water collecting container 10 to the hydrogen water forming part 50 via the purification and sterilization part 30. That is, a pipe connecting from the purification and sterilization part 30 to the hydrogen water forming part 50 is provided with a fragrance mixing part 70. The fragrance mixing part 70 mixes fragrance into water for producing hydrogen water so as to improve the flavor of produced hydrogen water.

Additionally, a step of inserting liquid nitrogen into the hydrogen water container in accordance with the timing of blowing hydrogen (S7) may be further included. That is, a timing sensor 101 for sensing the timing of blowing hydrogen gas by the hydrogen blower 100 is installed at the hydrogen blower 100, and when the timing sensor 101 senses that the hydrogen blower 100 blows hydrogen gas into the hydrogen water container in the state in which a liquid nitrogen insertion part 120 for inserting liquid nitrogen into the hydrogen water container in accordance with the timing of blowing hydrogen gas, sensed by the timing sensor 101, is installed, the liquid nitrogen insertion part 120 immediately sprays liquid nitrogen at the head space of the hydrogen water container. Thus, hydrogen dissolved in the hydrogen water container is prevented from being eluted, dissolved oxygen in the head space of the hydrogen water container is removed, and the head space of the hydrogen water container is saturated with hydrogen gas, thereby supplying high-concentration hydrogen water.

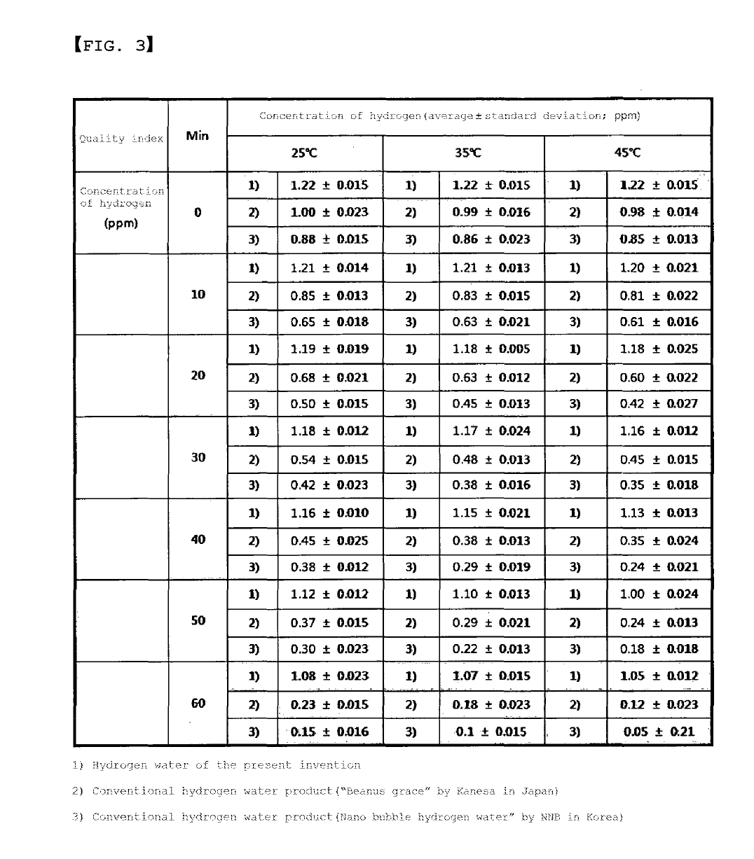

Next, FIG. 3 illustrates results of measuring changes in the concentration of hydrogen present in a conventional hydrogen water product and a hydrogen water product produced according to the present invention at 10-minute intervals for an hour after the products are opened, and FIG. 4 illustrates results of measuring changes in the concentration of hydrogen present in a conventional hydrogen water product and a hydrogen water product produced according to the present invention at one-month intervals for 12 months in the state the products are not opened, so as to estimate the long-term preservation of the products. Changes in the hydrogen concentration of an experimental embodiment of hydrogen water produced according to the above-described present invention are described as follows.

For reference, in the following experimental embodiments, a percentage (%) with respect to a hydrogen concentration denotes a final hydrogen concentration with respect to an initial hydrogen concentration, and the content of hydrogen is calculated through a formula (final hydrogen concentration/initial hydrogen concentration)×100.

### Experimental Embodiment 1

### Measuring Changes in the Concentration of Dissolved Hydrogen after a Hydrogen Water Product of the Present Invention is Opened

Changes in the hydrogen concentration of three lots (repeated three times per lot) of hydrogen water products (packaged in aluminum cans) produced according to an apparatus and a method for producing hydrogen water of the present invention were observed for 10-minute intervals while the three lots were stored in a thermo-hygrostat at 25° C., 35° C. and 45° C. for an hour. In this case, the hydrogen water products were stored in the state of being opened. As a control group, “Beanus grace”, which is reduced hydrogen water (electrolyzed hydrogen water), produced by Kanesa in Japan and packaged in an aluminum can), and nano bubble hydrogen water, which is injected with hydrogen gas, produced by NNB in Korea and packaged in an aluminum pouch, were used.

A hydrogen concentration is measured using a system equipped with DH-35A, a sensor for dissolved hydrogen, manufactured by Dong-A DKK.

TABLE 1

| | Experimental condition |
|---|---|
| Storage temperature | 35° C., 45° C. |
| Control (distribution) | 25° C. |
| temperature | |
| Storage period | 1 hour |
| Measurement temperature | 20° C. |
| Frequency of experiments | 6 times |
| Frequency of repeating | Three times per lot |
| experiments | (three lots, nine times) |

The initial hydrogen content of hydrogen water of the present invention was 1.22±0.015 ppm. This showed that high-concentration hydrogen was contained in the hydrogen water of the present invention. FIG. 3 illustrates results of measuring changes in the hydrogen concentration of the hydrogen water products for an hour. Compared to the initial hydrogen concentration, the hydrogen concentration of the conventional hydrogen water products ranged from 12.24 to 23.00% (reduced hydrogen water) or ranged from 5 to 17% (nano bubble hydrogen water) after an hour. Thus, the conventional hydrogen water products have a problem with preserving and maintaining the content of hydrogen. However, the hydrogen concentration of the hydrogen water product produced according to the present invention was at least 86.07 to 88.12%. As described above, the hydrogen concentration of the hydrogen water product produced according to the present invention was maintained at least 1.0 ppm even after an hour. Thus, the hydrogen water product of the present invention is thought to be more effective in the human body than the conventional hydrogen water products.

In particular, FIG. 3 shows that hydrogen was abundantly contained in the hydrogen water produced according to the present invention even at temperatures ranging from room temperature (25° C.) to 45° C. While the hydrogen concentration of the conventional hydrogen water products as a control group merely ranged from 0.1 ppm to 0.2 ppm at temperatures from room temperature (25° C.) to 45° C. one hour after the conventional hydrogen water products were opened, the hydrogen concentration of the hydrogen water product of the present invention was at least 1 ppm at temperatures from room temperature (25° C.) to 45° C. one hour after the hydrogen water product of the present invention was opened.

After opened, conventional beverages containing gas discharge gas fast when temperature rises above room temperature. On the contrary, after opened, hydrogen in the hydrogen water produced by means of the apparatus and method for producing hydrogen water of the present invention was maintained for a certain period of time even when temperature rose above room temperature.

### Experimental Embodiment 2

### Confirmation of the Quality of Hydrogen Water of the Present Invention in Relation to Long-Term Preservation

In order for an expiry date of a hydrogen water product of the present invention to be determined, changes in the hydrogen concentration of three lots (repeated three times per lot) of hydrogen water products (packaged in aluminum cans) produced according to an apparatus and a method for producing hydrogen water of the present invention were observed for one-month intervals while the three lots were stored in a thermo-hygrostat at 25° C., 35° C. and 45° C. for twelve months. In this case, the hydrogen water products were stored in the state where the hydrogen water products were not opened. As a control group, “Beanus grace”, which is reduced hydrogen water (electrolyzed hydrogen water), produced by Kanesa in Japan and packaged in an aluminum can), and nano bubble hydrogen water, which is injected with hydrogen gas, produced by NNB in Korea and packaged in an aluminum pouch, were used.

A hydrogen concentration is measured using a system equipped with DH-35A, a sensor for dissolved hydrogen, manufactured by Dong-A DKK.

TABLE 2

| | Experimental condition |
|---|---|
| Storage temperature | 35° C., 45° C. |
| Control (distribution) | 25° C. |
| temperature | |
| Storage period | 12 months |
| Measurement temperature | 20° C. |
| Frequency of experiments | 6 times |
| Frequency of repeating | Three times per lot |
| experiments | (three lots, nine times) |

FIG. 4 illustrates results of measuring changes in the hydrogen concentration of the hydrogen water products for twelve months. Contrary to the initial hydrogen concentration, the hydrogen concentration of the conventional hydrogen water products ranged from 30 to 38% (reduced hydrogen water) or ranged from 27 to 34% (nano bubble hydrogen water) twelve months later. Thus, the conventional hydrogen water products have a problem with preserving and maintaining the content of hydrogen. However, the hydrogen concentration of the hydrogen water product produced according to the present invention was at least 86 to 88%.

The hydrogen content of the hydrogen water product produced according to the above-described present invention is thought to be higher than that of the conventional hydrogen water products, and the shelf life of the hydrogen water product produced according to the present invention is thought to be more than twice as long as that (four to six months) of the conventional hydrogen water products.

### Experimental Embodiment 3

### Confirmation of the Positive Effects of Hydrogen Water of the Present Invention on Particulate Matter-Induced Diseases

### <3-1> Changes in the Body Weight and the Weight of the Lungs of a Model with Pneumoconiosis

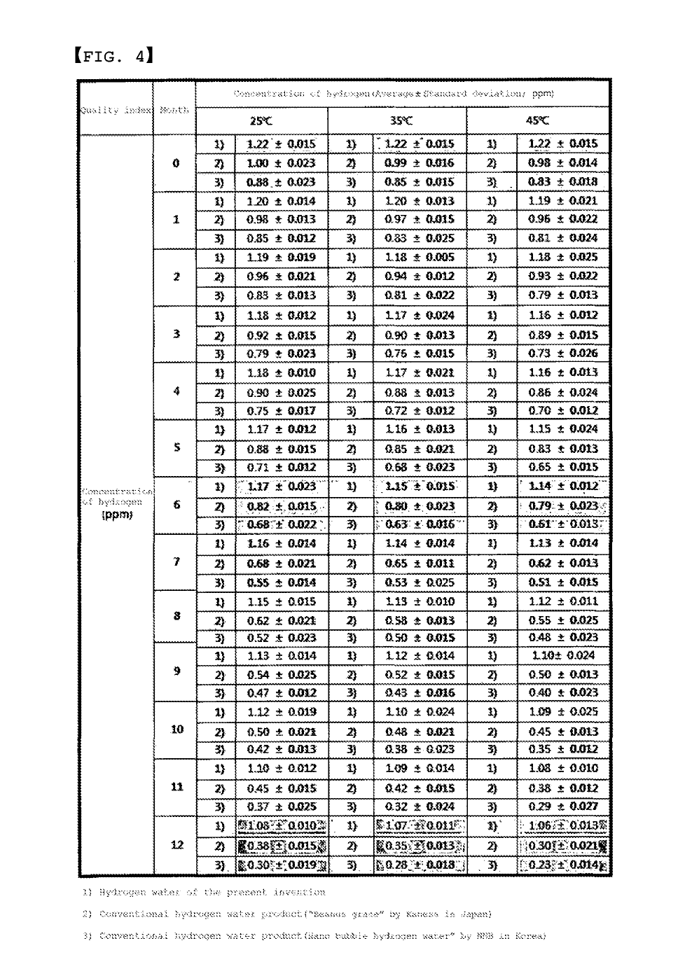

FIG. 5A illustrates an outline of an animal experiment. Specifically, a wistar rat (n=7/group) was provided with purified water (PW10 or PW30) and hydrogen water (HW10 or HW30) twice per day for ten weeks (oral administration through a drinking fountain) in doses listed in Table 3. As illustrated in FIG. 5B, particulate matter (CNP; carbon nanoparticles, Sigma-Aldrich Korea. Carbon Nanopowder) the diameter of which ranges 20 nm to 500 nm was directly sprayed (10-30 mL sprayed per kg of body weight) into the bronchi four weeks so as to cause particulate matter-induced pneumoconiosis, after the experimental materials were provided. Then, the experimental materials were further administered for six weeks. The weight of experimental animals was measured once per week while the experimental materials were administered for ten weeks. After the experimental materials were administered for ten weeks, autopsies were performed on the experimental animals so as to examine the levels of accumulated particulate matter and damage in the lung tissue of the experimental animals, and the reaction in the immune system in blood.

TABLE 3

| | | | The Number |
|---|---|---|---|
| Experimental group | Mark | Dose | of animals |
| Control group (normal) | Normal | — | 7 |
| Group where | CNP | — | 7 |
| pneumoconiosis | | | |
| developed | | | |
| Group where | PW10 | 10 | 7 |
| pneumoconiosis | | ml/kg/day | |
| developed + group | | | |
| with low doses of | | | |
| purified water | | | |
| Group where | PW30 | 30 | 7 |
| pneumoconiosis | | ml/kg/day | |
| developed + group | | | |
| with high doses | | | |
| of purified water | | | |
| Group where | HW10 | 10 | 7 |
| pneumoconiosis | | ml/kg/day | |
| developed + group | | | |
| with low doses of | | | |
| hydrogen water | | | |
| Group where | HW30 | 30 | 7 |
| pneumoconiosis | | ml/kg/day | |
| developed + group | | | |
| with high doses | | | |
| of hydrogen water | | | |

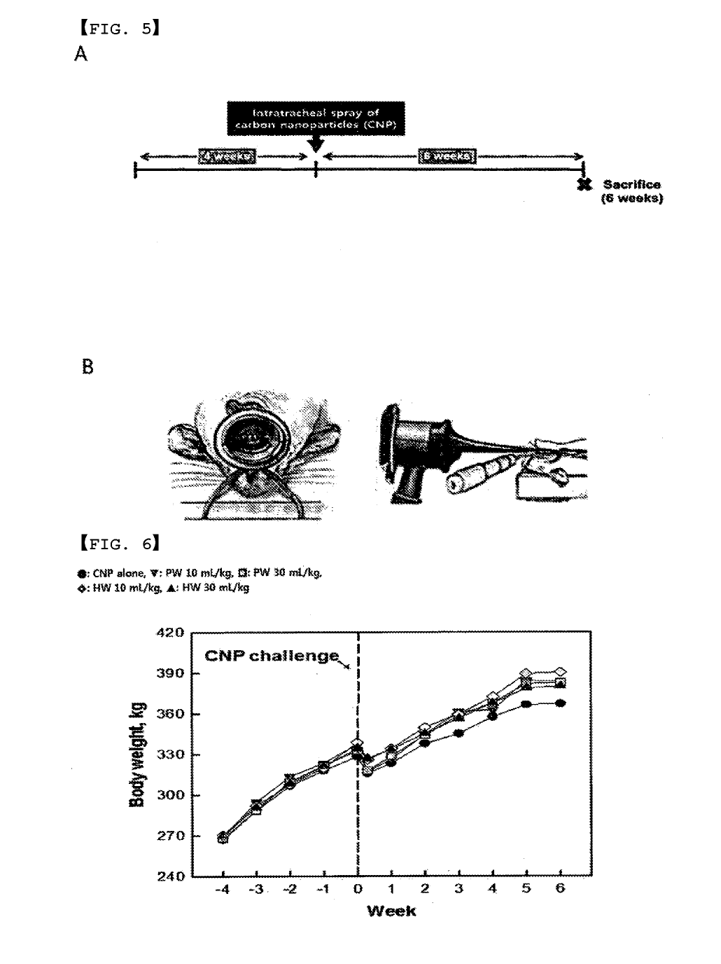

FIG. 6 and Table 4 show that the body weight of rats decreased and then increased when particulate matter was sprayed into the bronchi of the rats the body weight of which normally increased (CNP challenge). The body weight of rats provided with purified water or hydrogen water increased a little faster.

Additionally, the weight of the lungs of rats exposed to particulate matter (CNP challenge) increased. It is thought that this resulted from the accumulated particulate matter and inflammatory responses. The weight of the lungs of the group where hydrogen water of the present invention was administered decreased up to a level similar to that of the lungs of the normal group, contrary to the group where purified water was administered (ref. Table 4).

### <3-2> Confirmation of Effects on Suppressing the Accumulation of Particulate Matter in the Body and on Preventing and Treating Pneumoconiosis

The levels of accumulated particulate matter and damage in the lungs of the experimental animals in <3-1> were confirmed. An experimental method is specifically described as follows. Tissue was fixed with a neutral formalin solution and treated by means of usual operations of treating tissue so that a paraffin tissue slide may be made. Then the tissue was stained with hematoxylin-eosin, and levels of carbon nanoparticles and inflammation in the lung tissue were observed with an optical microscope.

Additionally, effects of hydrogen water on the suppression (removal) of the accumulation of particulate matter in blood and the activation of phagocytes of macrophages were confirmed through a following method.

Specifically, a carbon suspension (Pelikan c11/1432a, Barcelona, Spain) was centrifuged at 5,000 rpm for 15 minutes, and the supernatant liquid is diluted threefold in a saline solution containing 1.5% of gelatin so that a 30 mg/ml carbon suspension (particulate matter sample) may be produced. Each of the experimental materials (PW10, PW30, HW10, HW30) was orally administered into a male ICR mouse for seven days, the carbon suspension was intravenously injected into the male ICR mouse in a dose of 10 ml/kg on the next day, and then 50 μl of blood was drawn from the male ICR mouse 0.5 minute and 10 minutes later. 1 ml of 0.1% Na₂CO₃ liquid was added to 50 μl of the drawn blood so as to destruct red blood cells, absorbance was measure at 600 nm, and a carbon clearance (removal) rate was measured. Additionally, K (phagocytic index) was deducted through the following formula on the basis of the measured absorbance. In the following formula, C_{0.5} and C₁₀ respectively denote the concentration of carbon at t_{0.5} and t₁₀.

$$K = \frac{1}{{t}_{10} - {t}_{0.5}} log \frac{{C}_{0.5}}{{C}_{10}}$$

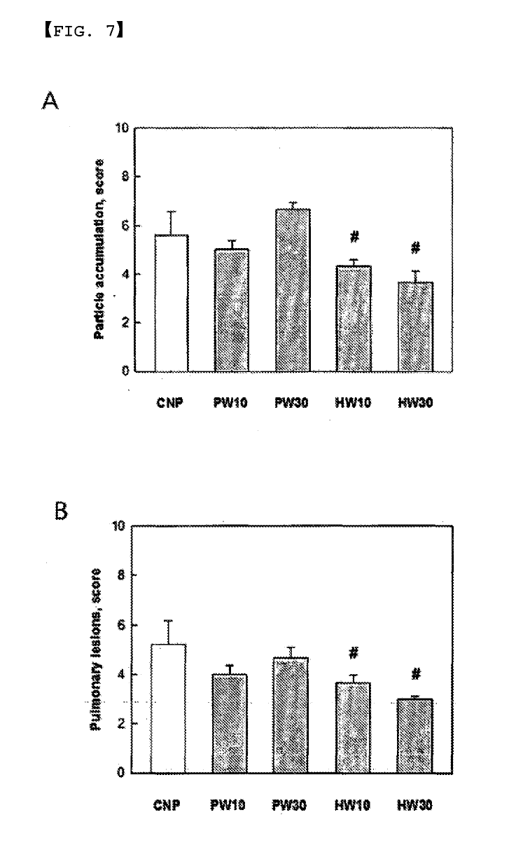

As illustrated in FIG. 7, when particulate matter was sprayed into the bronchi, pneumoconiosis develops while the particulate matter was significantly accumulated in the lungs (5.6 out of 10 points, FIG. 7A) and the lungs were damaged (5.2 out of 10 points, FIG. 7B). The levels of accumulated particulate matter and lung damage in the group in which purified water was administered were similar to those in the CNP group. Thus, purified water did not have a meaningful effect on pneumoconiosis. In particular, the level of accumulated particulate matter in the PW30 group was higher than that in the CNP group. On the contrary, the levels of accumulated particulate matter and lung damage in the group in which hydrogen water of the present invention was administered were meaningfully lowered. Thus, the significant effects of hydrogen water of the present invention on preventing and treating pneumoconiosis were confirmed. Additionally, the effects of hydrogen water on preventing and treating pneumoconiosis were highly dependent on the dose of the hydrogen water.

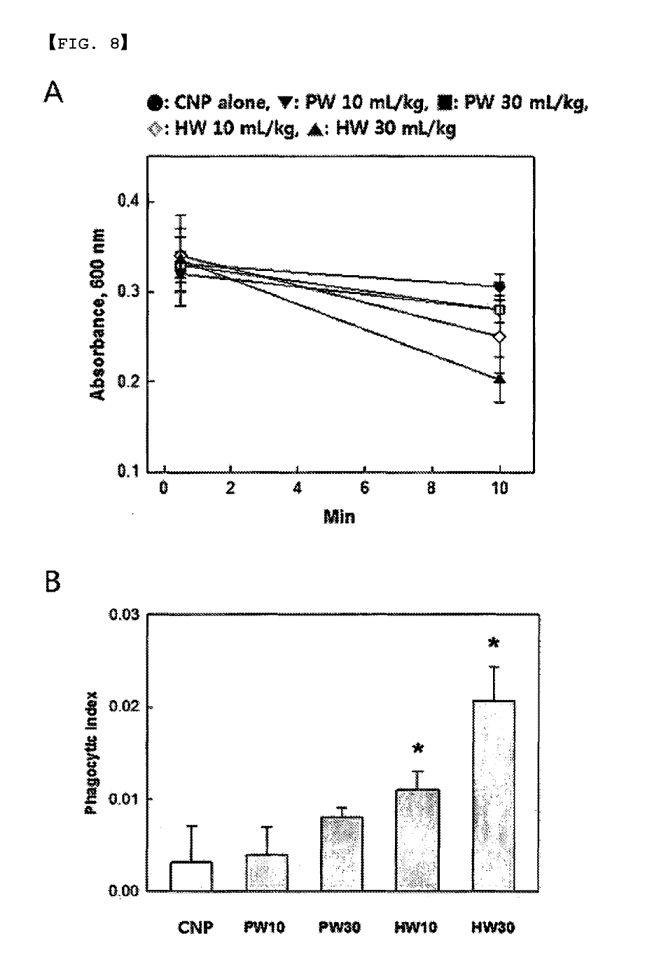

Further, as illustrated in FIG. 8, particulate matter (carbon particle) directly injected into the blood in the group treated with hydrogen water of the present invention was significantly reduced compared to the group in which purified water was administered (FIG. 8A). In particular, the particulate matter (carbon) clearance rate in the blood of the HW10 group was 3.5 times higher than that of the CNP group as a positive control group while the particulate matter (carbon) clearance rate in the blood of the HW30 group was 6.7 times higher than that of the CNP group. Further, the activation of phagocytes of macrophages of the group treated with hydrogen water of the present invention significantly increased (FIG. 8B).

Hydrogen water of the present invention, as described above, significantly suppressed the accumulation of particulate matter and removed particulate matter in the lungs and blood, and significantly improved and alleviated the symptoms of pneumoconiosis caused by particulate matter.

### <3-3> Effects on Suppressing Particulate Matter-Induced Allergy

The blood of the experimental animal in <3-1> was analyzed. As illustrated in Table 5, it turned out that that the number of monocytes and white blood cells (WBC) was reduced after particulate matter was sprayed. Thus, particulate matter is thought to undermine the immune system and cause a reduction in the number of platelets. Additionally, carbon nanoparticles are thought to cause an increase in the number of eosinophils, which is one of the causes of allergies. On the contrary, hydrogen water of the present invention meaningfully reduced the number of eosinophils involving allergic reactions (ref. Table 5).

### <3-4> Effects on Suppressing Inflammation

It is known that various diseases such as pneumoconiosis caused by particulate matter are accompanied by inflammatory responses. As in <3-2>, hydrogen water of the present invention increased the activation of macrophages, and in general, it is known that activated macrophages secrete an inflammatory mediator such as NO etc. and involves an inflammatory repose. Accordingly, the effect of hydrogen water of the present invention on inflammation was confirmed. A specific method for performing an experiment is described as follow.

RAW264.7 cells as a macrophage cell line were used, divided by 1×10⁶ cells/ml per well in microwell plates and cultured at 37° C. A complex treatment was performed on the positive control group and experimental groups with interferon-γ (IFN-γ, 10 U/ml) and lipopolysaccharide (LPS, 10 μg/ml). Then the experimental groups were treated with purified water (PW1, PW5, PW10, PW20) or hydrogen water of the present invention (HW1, HW5, HW10, HW20). After treated, the control and experimental groups were cultured in a CO₂ incubator for 48 hours at 37° C. After 48 hours, 100 μl of each culture liquid was collected and reacted with the same amount of Griess reagent (1% sulfanilamide, 0.1% N-1-naphthylethylenediamine dihydrochloride, 2.5% phosphoric acid) for 10 minutes, and absorbance was measured at the wavelength of 540 nm so that the content of nitrite from a nitrite standard curve was quantified.

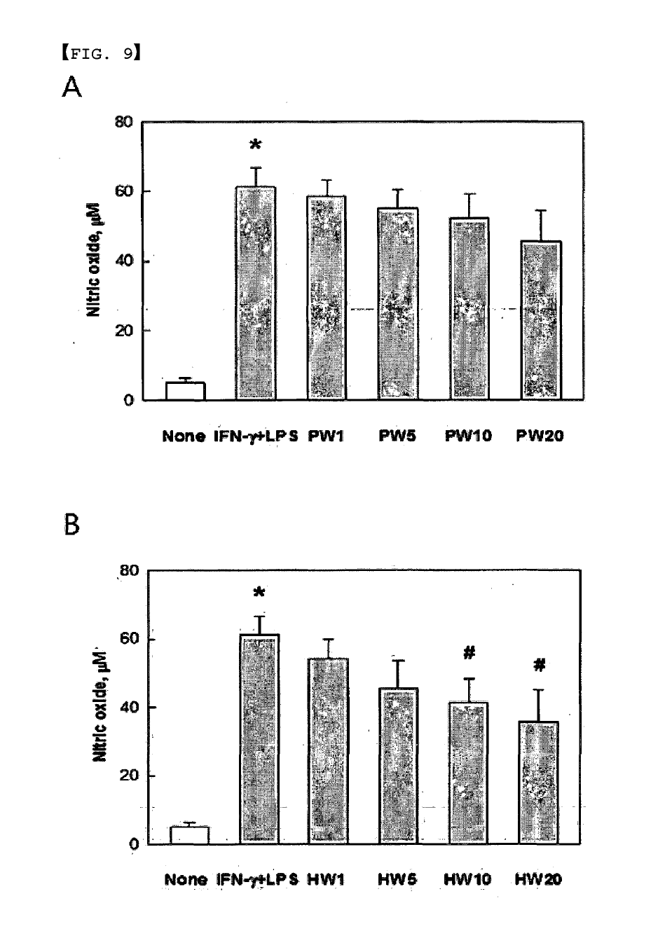

As a result of the experiment, macrophages stimulated with IFN-γ and LPS, as illustrated in FIG. 9, secreted a large amount of NO. Hydrogen water of the present invention meaningfully suppressed the secretion of NO (FIG. 9B) while purified water had almost no effect on suppressing the secretion of NO (FIG. 9A). In general, activated macrophages are known for inducing inflammatory responses. Hydrogen water of the present invention suppressed the inflammation-related activation of macrophages while selectively increasing the activation of phagocytes as in experimental embodiment <3-2>.

A person having ordinary skill in the art to which the present invention pertains will understand that the present invention may be embodied in many different forms within the technical spirit and essential features thereof. Therefore, it should be understood that the above-described embodiments and experimental embodiments are provided only as examples and that the present invention is not construed as being limited to the embodiments and experiments. It should be further understood that the scope of the present invention is defined only according to the appended claims rather than the detailed description of the invention and that all the modifications and modified forms drawn from the meaning, scope and equivalent concept to which the claims are entitled are included within the scope of the present invention.

### DESCRIPTION OF THE SYMBOLS

10: Water collecting container
20: Pump
30: Purification and sterilization part
40: First hydrogen gas supply part
50: Hydrogen water forming part
60: Controller
70: Fragrance mixing part
80: Hydrogen water packaging part
90: Container insertion part
100: Hydrogen blower
101: Timing sensor
110: Second hydrogen gas supply part
120: Liquid nitrogen insertion part
130: Seaming part

1. An apparatus for producing hydrogen water, comprising:
a purification and sterilization part for purifying and sterilizing water for producing hydrogen water;
a hydrogen water forming part for providing hydrogen gas to the water having been purified and sterilized in the purification and sterilization part so as to form hydrogen water;
a hydrogen water packaging part for packaging the hydrogen water having been formed in the hydrogen water forming part into a hydrogen water container;
a hydrogen blower for blowing and injecting hydrogen gas into the hydrogen water container having gone through the hydrogen water packaging part to a saturated state; and
a seaming part for sealing the hydrogen water container after the hydrogen blower blows hydrogen gas so as to prevent the hydrogen gas from leaking, wherein:
the apparatus for producing hydrogen water, further comprises a timing sensor for sensing the timing of blowing hydrogen gas by the hydrogen blower, and
a liquid nitrogen insertion part for inserting liquid nitrogen into the hydrogen water container in accordance with the timing of blowing hydrogen gas, sensed by the timing sensor, so as to prevent hydrogen dissolved in the hydrogen water container from being eluted and to remove dissolved oxygen at the head space of the hydrogen water container.

2. (canceled)

3. A method for producing hydrogen water, comprising:
a first step of purifying and sterilizing water for producing hydrogen water;
a second step of providing hydrogen gas to the water having been purified and sterilized so as to form hydrogen water;
a third step of packaging the hydrogen water having been formed in the second step into a hydrogen water container;
a fourth step of blowing and injecting hydrogen gas into the hydrogen water container having gone through the third step to a saturated state; and
a fifth step of sealing the hydrogen water container after the blowing of hydrogen gas so as to prevent the hydrogen gas from leaking,
wherein the method further comprises inserting liquid nitrogen into the hydrogen water container in accordance with the timing of blowing hydrogen gas, so as to prevent hydrogen dissolved in the hydrogen water container from being eluted and to remove dissolved oxygen at the head space of the hydrogen water container.

4-5. (canceled)

6. Food composition for suppressing the accumulation of particulate matter in the body, which comprises the hydrogen water produced using the apparatus of claim 1 as an active ingredient.

7. Food composition for discharging particulate matter out of the body, which comprises the hydrogen water produced using the apparatus of claim 1 as an active ingredient.

8. Food composition for preventing or alleviating pneumoconiosis, which comprises the hydrogen water produced using the apparatus of claim 1 as an active ingredient.

9. The food composition for preventing or alleviating pneumoconiosis of claim 8, wherein pneumoconiosis is anthracosis.

10. (canceled)

11. Pharmaceutical composition for preventing or treating pneumoconiosis, which comprises the hydrogen water produced using the apparatus of claim 1 as an active ingredient.

12-18. (canceled)
